(19) United States
(12) Patent Application Publication
(10) Pub. No.: US 2018/0373218 A1
(43) Pub. Date: Dec. 27, 2018

(54) DEVICE AND METHOD FOR COMMON TYPE CONVERSION OF PLC CONTROL PROGRAM

(71) Applicant: UDMTEK CO., LTD., Gyeonggi-do (KR)

(72) Inventors: Gi Nam WANG, Gyeonggi-do (KR); Seung Hoon AHN, Seoul (KR); Jun Pyo PARK, Jeollabuk-do (KR); Seok Myung JIN, Gyeonggi-do (KR); Ho Chul PARK, Gyeonggi-do (KR)

(21) Appl. No.: 16/063,383

(22) PCT Filed: Aug. 26, 2016
(86) PCT No.: PCT/KR2016/009490

§ 371 Date: Jun. 18, 2018

(30) Foreign Application Priority Data
Dec. 17, 2015 (KR) 10-2015-0181242

(51) Int. Cl. G05B 19/05; G06F 8/30

(52) U.S. Cl. CPC G05B 19/056; G05B 2219/13152; G06F 8/30

(57) ABSTRACT

A device and a method for common type conversion of a PLC control program are disclosed. The device for common type conversion of a PLC control program according to an embodiment of the present invention comprises: a common command library construction unit for constructing a common command library by generating, using a common command generation algorithm, a common command for commands used in text-based PLC control programs having different types; and a common type conversion unit for converting an arbitrary text-based PLC control program into a common type PLC control program by using the common command library, in accordance with the arbitrary text-based PLC control program requested to be converted into a common type being able to be converted into a common type PLC control program.

### FIELD

The present invention relates to an device and a method for common type conversion of a programmable logic controller (PLC) control program, and more particularly, to an device and a method for common type conversion of a PLC control program, in which PLC control programs having different text forms for each PLC manufacturer are converted into a common type PLC control program.

### BACKGROUND

A programmable logic controller (PLC) is a controlling device which secures stability for controlling a process of an automation industry and has been developed from a need of a controller which is programmable to correspond to frequent changes in an on-site system caused by small quantity batch production, has a small size, and is comparatively free in changing the system.

Programming languages for operating the PLC includes a ladder diagram (LD), a function block diagram (FBD), a structured text (ST), an instruction list (IL), a sequential function chart (SFC), a continuous function chart (CFC), and the like and are defined in International Electrotechnical Commission (IEC) 61131-3.

A structure of a PLC control program may be largely divided into tag information which includes information on contacts of a PLC and logic information which includes information on a PLC control program which is being driven. Among them, the logic information is a most basic element in operating an automation process and includes all pieces of information on a sequence, conditions, and the like for controlling facilities/process/line so as to be used as core information for managing and analyzing a process in a recent situation in which interest in a method of optimizing process management has been increased.

A control logic of a PLC control program is programmed using an LD among a variety of PLC programming languages in most industrial settings due to immediacy and simplicity of language. The LD arranges contacts for output for each step in an AND and OR structure and allows a sequence, conditions, and the like for controlling a process to be drafted using a variety of arithmetic operations, functions, and the like.

A PLC control program drafted using the LD is converted into a text-based PLC control program for processing and analysis. Text-based PLC control programs have different forms according to PLC manufactures. MITSUBISHI ELECTRIC and LSIS Co., Ltd, which are PLC manufactures, express a control logic of a PLC control program in text by using an IL. SIEMENS expresses a control logic of a PLC control program in text by using a standard template library (STL). Rockwell Automation expresses a control logic of a PLC control program in text according to its platform.

Users may intuitionally or easily understand a control logic of a PLC control program drafted in an LD by using PLC programming software provided by each PLC manufacturer.

Since a control logic of a text-based PLC control program which is extracted for analyzing process management has a different structure for each PLC manufacturer instead of the LD, users should understand an expression method of the control logic of the PLC control program for each PLC manufacturer in order to analyze the control logic of the PLC control program for each PLC manufacturer.

However, in order to understand or learn all expression methods of control logics of PLC control programs of PLC manufacturers, users should spend a large amount of time and effort thereon.

### SUMMARY

### Technical Problem

Present invention is directed to providing an device and a method for common type conversion of a programmable logic controller (PLC) control program, which are capable of converting a PLC control program into a common type so as to easily analyze a control logic of the PLC control program even when all expression methods of control logics of PLC control programs of PLC manufacturers are not understood or learned.

Aspects of the present invention is not limited to the above-stated aspect, and unstated other aspects will be clearly understood by those skilled in the art from the following description.

### Technical Solution

One aspect of the present invention provides a common type conversion device for a programmable logic controller (PLC) control program, which includes a common command library construction portion which generates a common command with respect to commands used in text-based PLC control programs having different formats by using a common command generation algorithm so as to construct a common command library and a common type conversion portion, when a random text-based PLC control program requested to be a common type is convertible into a common type PLC control program, converting the random text-based PLC control program into the common type PLC control program by using the common command library.

The common command generation algorithm may include a first operation of classifying the commands used in text-based PLC control programs having different formats into same expression command groups having the same meaning in expression, a second operation of checking whether commands included in one of the same expression command groups have the same function, and a third operation of generating, when the commands included in the same expression command group have the same function, a word in dictionary, which equally expresses the commands included in the same expression command group, as a common command with respect to the commands having the same function, generating, when all the commands included in the same expression command group do not have the same function, a word in dictionary, which expresses all the commands which are included in the same expression command group but do not have the same function, as a common command with respect to the commands which do not have the same function, and inserting a title of a manufacturer of a PLC controlled by a PLC control program in which the commands which do not have the same function are used, into the common command with respect to the commands which do not have the same function.

The third operation may include inserting, when the common command with respect to the commands having the same function is generated, a parameter modifier included in the commands having the same function into the common command with respect to the commands having the same function.

The third operation may include inserting, when the common command with respect to the commands having the same function is generated, an operation modifier included in the commands having the same function into the common command with respect to the commands having the same function.

The third operation may include inserting, when the common command with respect to the commands which do not have the same function is generated, a parameter modifier included in the commands which do not have the same function into the common command with respect to the commands which do not have the same function.

The third operation may include inserting, when the common command with respect to the commands which do not have the same function is generated, an operation modifier included in the commands which do not have the same function into the common command with respect to the commands which do not have the same function.

The common type PLC control program may be expressed in a common type for at least one RUNG which forms a control logic of the text-based PLC control program

A common type RUNG may be started by combining a letter “N” with a step index of a contact located at a foremost position of a text-based RUNG among inner contacts of the text-based RUNG.

in the common type RUNG, at least one contact in the text-based RUNG may be expressed as a common object which includes a common command and a tag, and a combination relationship among one or more common blocks generated by blocking one or more common objects may be expressed as at lest one of symbols “[”, “]”, and “,”.

The common type conversion portion may include an instruction list (IL) object generator configured to generate, when a random text-based PLC control program requested to be a common type is convertible into a common type PLC control program, at least one contact as an IL object which includes a command and a tag according to a logic sequence for each RUNG which constitutes a control logic of the random text-based PLC control program, an IL block generator configured to generate one or more IL blocks by blocking one or more IL objects by using a block command, a common block converter configured to convert the one or more IL blocks into one or more common blocks by generating a common object through conversion of a command into a common command for each of the one or more IL objects in the one or more IL blocks by using the common command library, and a combination relationship expresser configured to express a combination relationship among the one or more common blocks as at least one of the symbols “[”, “]”, and “,” by using a combination command.

Another aspect of the present invention provides a common type conversion method for a PLC control program, which includes constructing a common command library by generating a common command with respect to commands used in text-based PLC control programs having different formats by using a common command generation algorithm, checking, according to a request for converting a random text-based PLC control program into a common type, whether the random text-based PLC control program is convertible into the common type PLC control program by using a filename extension and a data structure of the random text-based PLC control program, and converting, when the random text-based PLC control program is convertible into the common type PLC control program, the random text-based PLC control program into the common type PLC control program by using the common command library.

The converting of the random text-based PLC control program into the common type PLC control program may include generating, when a random text-based PLC control program requested to be a common type is convertible into a common type PLC control program, at least one contact as an IL object which includes a command and a tag according to a logic sequence for each RUNG which constitutes a control logic of the random text-based PLC control program, generating one or more IL blocks by blocking one or more IL objects by using a block command, converting the one or more IL blocks into one or more common blocks by generating a common object through conversion of a command into a common command for each of the one or more IL objects in the one or more IL blocks by using the common command library, and expressing a combination relationship among the one or more common blocks as at least one of the symbols “[”, “]”, and “,” by using a combination command.

### Advantageous Effects

According to embodiments of the present invention, in an device and a method for common type conversion of a programmable logic controller (PLC) control program, a PLC control program is converted into a common type such that a control logic of the PLC control program may be easily analyzed even when users do not understand or learn all expression methods of control logics of PLC control programs of PLC manufacturers.

### BRIEF DESCRIPTION OF THE DRAWINGS

FIG. 1 is a block configuration diagram of a common type conversion device for common type conversion of a programmable logic controller (PLC) control program according to one embodiment of the present invention;

FIG. 2 is a diagram illustrating an example of an extensible mark-up language (XML) file format of a common command;

FIG. 3 is a block configuration diagram illustrating a common type conversion portion;

FIG. 4 is a view illustrating a data structure of Mitsubishi Developer including four columns in an order of StepNumber, Note, Command, Operand;

FIG. 5 is a view illustrating an unconvertible common type case;

FIG. 6 is a view illustrating text-based Mitsubishi PLC control program for a Mitsubishi PLC control program having a laser disc (LD) structure;

FIG. 7 is a view illustrating IL objects;

FIG. 8 is a view illustrating IL blocks;

FIG. 9 is a view illustrating a process of expressing a combination relationship among common blocks in a common type by applying a combination command OR to the common blocks shown in FIG. 8;

FIG. 10 is a view illustrating a process of expressing a combination relationship among the common blocks in a common type by applying a combination command ANB to the common blocks after applying the combination command OR to the common blocks as shown in FIG. 9;

FIG. 11 is a view illustrating a process of expressing a combination relationship among the common blocks by applying a combination command ORB to the common blocks in a common type after applying the combination command ANB to the common blocks as shown in FIG. 10;

FIG. 12 is a view illustrating shapes of the common blocks obtained by applying OR, ANB, and ORB to the common blocks shown in FIG. 8;

FIG. 13 is a view illustrating a result of applying a combination command MPS used by an output portion to the common blocks shown in FIG. 12;

FIG. 14 is a view illustrating a result of applying a combination command MRD used by the output portion to the common blocks shown in FIG. 12;

FIG. 15 is a view illustrating a result of applying a combination command MPP used by the output portion to the common blocks shown in FIG. 12;

FIG. 16 is a view illustrating shapes of the common blocks obtained by applying MPS, MRD, and MPP to the common blocks shown in FIG. 12;

FIG. 17 is a view illustrating a result of merging the common blocks obtained by applying a combination command used by an input portion and a combination command used by the output portion to the common blocks shown in FIG. 8;

FIG. 18 is a flowchart illustrating a common type conversion method for a PLC control program according to one embodiment of the present invention; and

FIG. 19 is a detailed flowchart illustrating an operation 50 shown in FIG. 18.

### DETAILED DESCRIPTION

Hereinafter, exemplary embodiments of the present invention will be described in detail with reference to the attached drawings.

The embodiments of the present invention are provided to more completely explain the present invention to one of ordinary skill in the art. The following embodiments may be modified in a variety of different forms, and the scope of the present invention is not limited thereto. The embodiments are provided to make the disclosure more substantial and complete and to completely convey the concept of the present invention to those skilled in the art.

The terms used herein are to explain exemplary embodiments and are not intended to limit the present invention. As used herein, singular forms, unless contextually defined otherwise, may include plural forms. Also, the terms “comprise” and/or “comprising” are used herein to specify the present of stated shapes, numbers, operations, members, elements, and/or groups thereof but do not preclude the presence or addition of one or more other shapes, numbers, operations, members, elements and/or groups thereof. As used herein, the term “and/or” includes any and all combinations or one of a plurality of associated listed items.

It is apparent that although the terms “first”, “second”, and the like are used herein to describe a variety of members, areas, layers, and/or portions, these members, areas, layers, and/or portions are not limited by these terms. These terms do not mean particular order, top and bottom, or ratings and are used only to distinguish one member, area, or portion from another member, area, or portion. Accordingly, a first member, area, or portion which will be described below may be referred to as a second member, area, or portion without departing from the scope of the present invention.

Hereinafter, the embodiments of the present invention will be described with reference to the drawings which schematically illustrate the embodiments. In the drawings, for example, depending on a manufacturing technology and/or tolerance, modifications of illustrated shapes may be made. Accordingly, it should be understood that the embodiments of the present invention are not limited to a particular shape of an area shown in the specification and may include, for example, a change in shape caused during a manufacturing process.

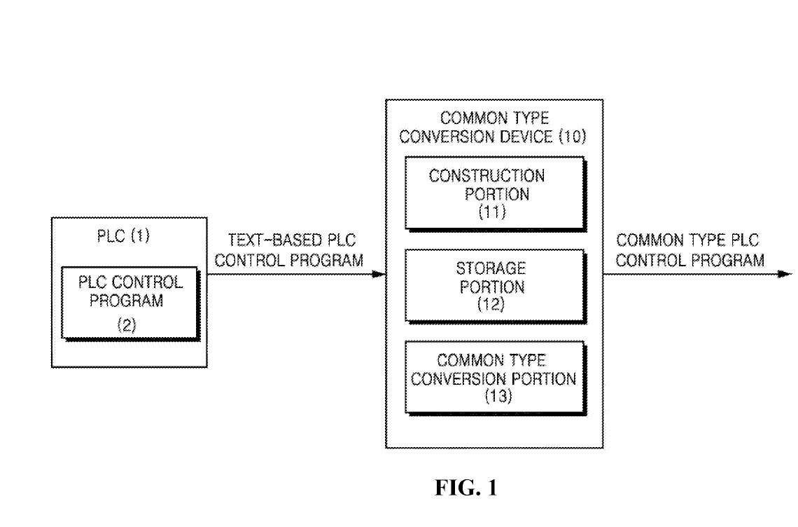

FIG. 1 is a block configuration diagram of a common type conversion device for common type conversion of a programmable logic controller (PLC) control program according to one embodiment of the present invention.

Referring to FIG. 1, a common type conversion device 10 for common type conversion of a PLC control program according to one embodiment of the present invention includes a construction portion 11, a storage portion 12, and a common type conversion portion 13.

The construction portion 11 constructs and stores a common command library in the storage portion 12 by generating a common type command for commands used in text-based PLC control programs having different formats according to a common command generation algorithm.

In order to smoothly construct the common command library, first, before starting construction of the common command library, command information used in a PLC control program for each PLC manufacturer and common command information corresponding thereto may be already stored or completely input to the construction portion 11.

When commands used in the PLC control program for each PLC manufacturer are prepared as described above, the construction portion 11 constructs the common command library according to a common command generation algorithm.

Here, the common command generation algorithm is an algorithm which sequentially performs a first operation, a second operation, and a third operation to generate a common command with respect to commands used in text-based PLC control programs having different forms.

The first operation is an operation of classifying commands used in the text-based PLC control programs having different forms into same expression command groups having same meanings in expression.

For example, with respect to a command which indicates “equal” in expression, MITSUBISHI ELECTRIC expresses “OR=”, Allen-Bradley (AB) expresses “EQU”, SIEMENS expresses “==I”, and LSIS expresses “OR=”. Accordingly, in the first operation, an “equal” command group may include “OR=” of MITSUBISHI ELECTRIC, “EQU” of AB, “==I” of SIEMENS, and “OR=” of LSIS.

Then, the second operation is an operation of checking whether all commands included in the same expression command group have the same function.

For example, in the second operation, it is checked whether “OR=,” “EQU,” “==I,” and “OR=,” which are included in the “equal” command group, have the same function.

The third operation is an operation of generating a common command using another type when all the commands included in the same expression command group do not have the same function.

First, when all the commands included in the same expression command group have the same function, a word in dictionary which equally expresses the commands which are included in the same expression command group and have the same function is generated as a common command with respect to the commands having the same function.

For example, since all of “OR=,” “EQU,” “==I,” and “OR=,” which are included in the “equal” command group, have the same function, “EQUAL” which is a word in dictionary and expresses “equal” may be generated as a common command with respect to the commands having the same function. However, the present invention is not limited to using only “EQUAL” which is a word in dictionary as the common command.

Also, when the common command is generated with respect to the commands having the same function, parameter modifiers included in the commands having the same function may be inserted into the common command with respect to the commands having the same function. When any one of modifiers which modify parameters of such commands, that is, D (double), BK (block), U (unsigned), G (group), R (real), L (long), 4 (4 bits), 8 (8 bits), $ (string), and C (complement) is included in a corresponding command, a parameter modifier may be inserted as a prefix into a common command of the corresponding command. However, a position in which a parameter modifier is inserted is not limited thereto.

For example, “DEQU” which is a command of AB with respect to “equal” is a command obtained by attaching a parameter modifier, D (double), to a command “EQU.” “D” modifies a parameter size of the command “EQU.” The command “EQU” is a command which processes 1 word (16 bits), and the command “DEQU” is a command which processes 2 words (32 bits). As described above, a parameter modifier which modifies a parameter of a command may be inserted as a prefix of a common command.

Also, when the common command is generated with respect to the commands having the same function, operation modifiers included in the commands having the same function may be inserted into the common command with respect to the commands having the same function. When an operation modifier which modifies an operation of a command, that is, any one of P (positive pulse) and N (negative pulse) is included in a corresponding command, the operation modifier may be inserted as a suffix into a common command of the corresponding command. However, a position of an operation modifier is not limited thereto.

For example, a command “ANDP” of MITSUBISHI includes “P (positive pulse)” which is an operation modifier for converting “AND,” which is a contact having a function of being turned on when an address value is turned on, into a positive pulse form. Accordingly, “XICP” which is a common command with respect to “ANDP” may be generated by attaching the operation modifier “P” as a suffix to “XIC (examine if closed) which is a common command with respect to “AND.”

Meanwhile, when all the commands included in the same expression command group do not have the same function, a word in dictionary which equally expresses commands which are included the same expression command group but do not have the same function may be generated as a common command with respect to the commands which do not have the same function. Also, titles of manufactures of PLCs controlled by PLC control programs in which the commands which do not have the same function are used may be inserted into the common command with respect to the commands which do not have the same function.

For example, as a case in which all the commands included in the same expression command group do not have the same function, a command “LIMIT” and the like are present. The command “LIMIT” is equally used as an expression in PLC control programs of MITSUBISHI, LSIS, and AB but does not have the same function therein. The command “LIMIT” is not used in a PLC control program of SIEMENS.

Accordingly, a common command with respect to the command “LIMIT” may be generated using “LIMIT” which is a word in dictionary. Since the command “LIMIT” does not perform the same function in each of PLC manufacturers, a title of each of PLC manufacturers may be inserted into the common command “LIMIT.” As an example, in the case of MITSUBISHI, SIEMENS, AB, and LSIS, “m”, “s”, “ab”, and “ls” may be inserted as prefixes into the common command “LIMIT,” respectively. That is, “mLIMIT” may be used in MITSUBISHI, “sLIMIT” may be used in SIEMENS, “abLIMIT” may be used in AB, and “lsLIMIT” may be used in LSIS.

Also, when the common command is generated with respect to the commands which do not have the same function, parameter modifiers included in the commands which do not have the same function may be inserted into the common command with respect to the commands which do not have the same function.

For example, “DLIMIT” which is a command of AB is obtained by attaching a parameter modifier, D (double), to the command “LIMIT.” “D” modifies a parameter size of the command “LIMIT.” The command “LIMIT” is a command which processes 1 word (16 bits), and the command “DLIMIT” is a command which processes 2 words (32 bits). A parameter modifier which modifies a parameter of a command as described above may be inserted into a common command and may be disposed after a prefix which indicates a PLC manufacturer, for example, “ab” which indicates AB.

Eventually, a common command with respect to the command “DLIMIT” of AB may be “abDLIMIT.”

Also, when the common command is generated with respect to the commands which do not have the same function, operation modifiers included in the commands which do not have the same function may be inserted into the common command with respect to the commands which do not have the same function. For example, a command “LIMITP” of MITSUBISHI includes an operation modifier “P (pulse)” for conversion into a positive pulse form and the command “LIMIT.” An operation modifier which modifies an operation of a command as described above may be inserted as a prefix into a common command. Accordingly, a common command with respect to the command “LIMITP” of MITSUBISHI may be “mLIMITP.”

Common commands generated by sequentially performing the first to third operations as described above may be converted into an extensible markup language (XML) file format to construct a common command library in the storage portion 12.

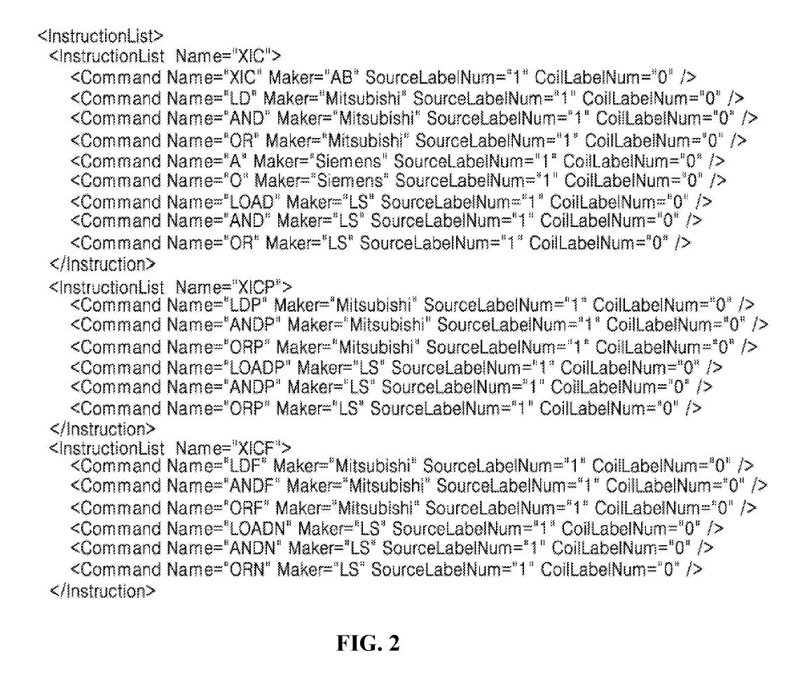

An example of the XML file format of the common command is shown in FIG. 2. Referring to FIG. 2, an XML file with respect to a common command includes a command corresponding to each of common commands (instructio such as “XIC,” “XICP,” and “XICF,” for each PLC manufacturer.

For example, a command “XIC” may correspond to the common command “XIC” in AB, each of “LD,” “AND,” and “OR” may correspond to the common command “XIC” in MITSUBISHI, “A” and “O” may correspond to the common command “XIC” in SIEMENS, and “LOAD,” “AND,” and “OR” may correspond to the common command “XIC” in LSIS.

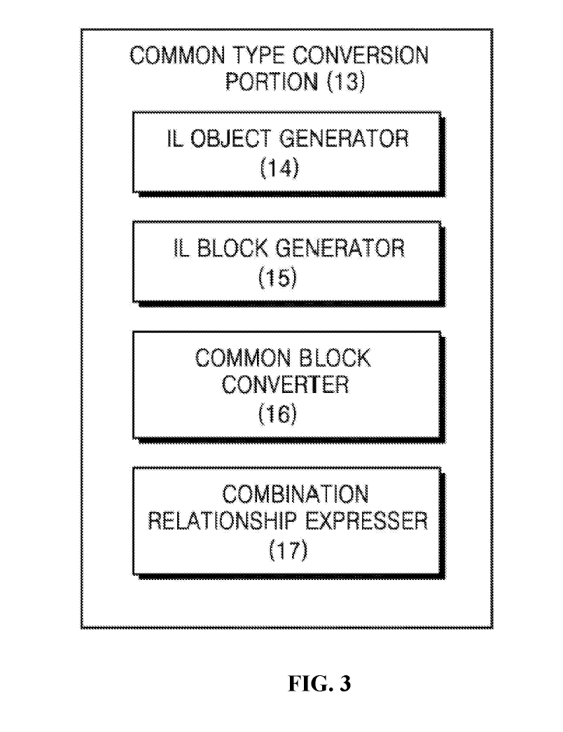

An operation of the common type conversion portion 13 shown in FIG. 3 when a request for conversion into a common type is present after the common command library is constructed through the above-described process will be described.

Since a random text-based PLC control program requested to be converted into a common type is convertible into a common type PLC control program, the common type conversion portion 13 converts the random text-based PLC control program into the common type PLC control program by using the common command library.

The common type conversion portion 13, as shown in FIG. 3, includes an IL object generator 14, an IL block generator 15, a common block converter 16, and a combination relationship expresser 17 and converts the random text-based PLC control program into the common type PLC control program.

The IL object generator 14 checks whether it is possible to convert the random text-based PLC control program requested to be converted into a common type into the common type PLC control program.

Here, whether the text-based PLC control program requested to be converted into the common type is convertible into a common type may be determined using at least one of a filename extension and a data structure of the random text-based PLC control program.

As an example, whether the text-based PLC control program requested to be converted into the common type is determined by primarily checking the filename extension of the random text-based PLC control program.

When the checked filename extension corresponds to a preset filename extension, secondarily, it is checked whether the data structure of the random text-based PLC control corresponds to a preset data structure.

When the data structure of the random text-based PLC control program corresponds to the preset data structure as a result of checking, it may be determined that the random text-based PLC control program is convertible into the common type PLC control program.

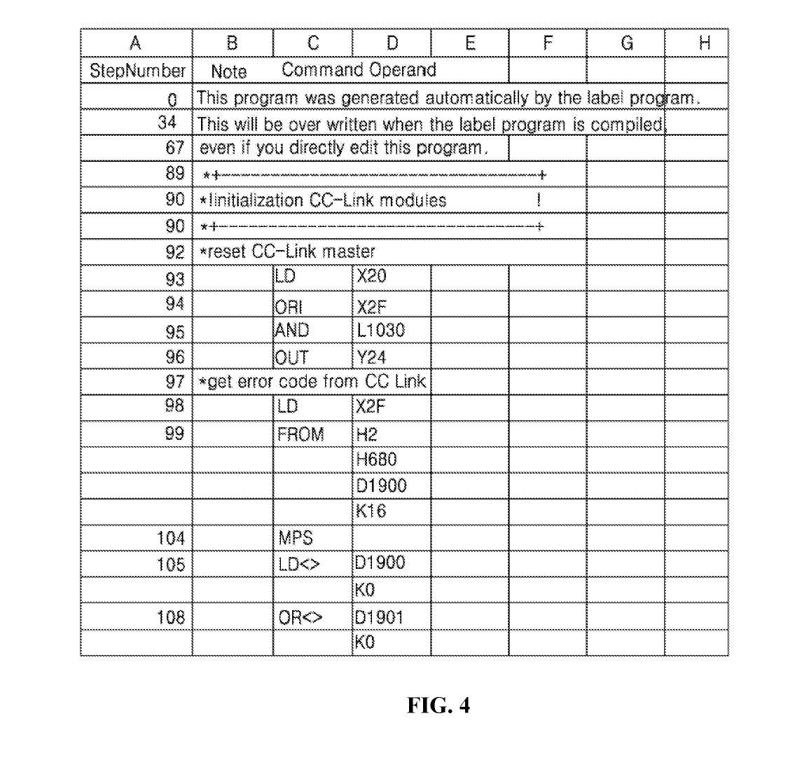

Here, the preset data structure may vary for each PLC control program for each PLC manufacturer and may be the number of columns. For example, a data structure of LSIS may include two columns, a data structure of MITSUBISHI Developer may include four columns (in an order of StepNumber, Note, Command, and Operand) as shown in FIG. 4, a data structure of MITSUBISHI Works2 may include eleven columns, and a data structure of MITSUBISHI Works3 may include twenty or more columns.

In the case of a data structure which is not one of the preset data structures, it is impossible to convert the random text-based PLC control program into the common type PLC control program.

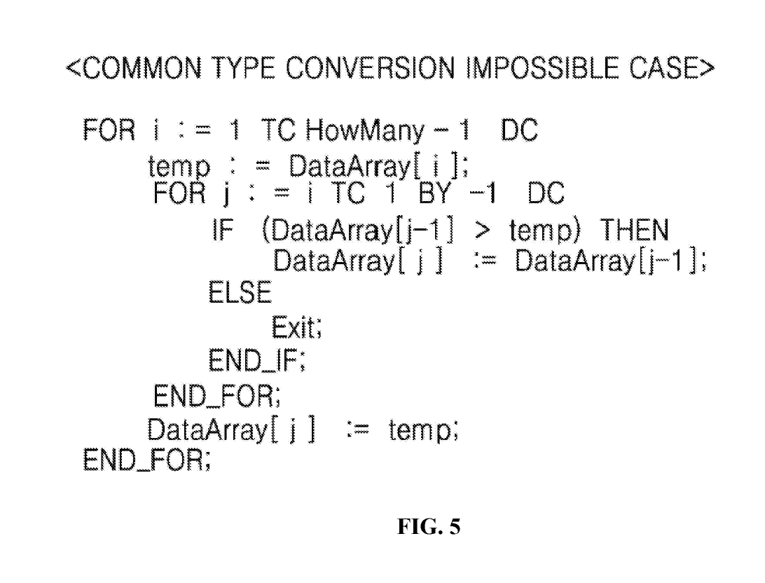

An example thereof is shown in FIG. 5.

Referring to FIG. 5, a logic called ST (StructuredText) of AB corresponds to an inconvertible case of common type conversion. As a reason of the logic being inconvertible into the common type, it is difficult to detect regularity because the logic is input in a free form such as .NET-based program codes. For example, how many times For statement is used, whether For statement is used being overlapped or separately used differs for each user.

Also, since in the inconvertible case of common type conversion into the common type, since a user freely defines an inner variable called “temp” and an address of the inner variable is not assigned to a particular area of a PLC memory, it is impossible to convert the inconvertible case into the common type.

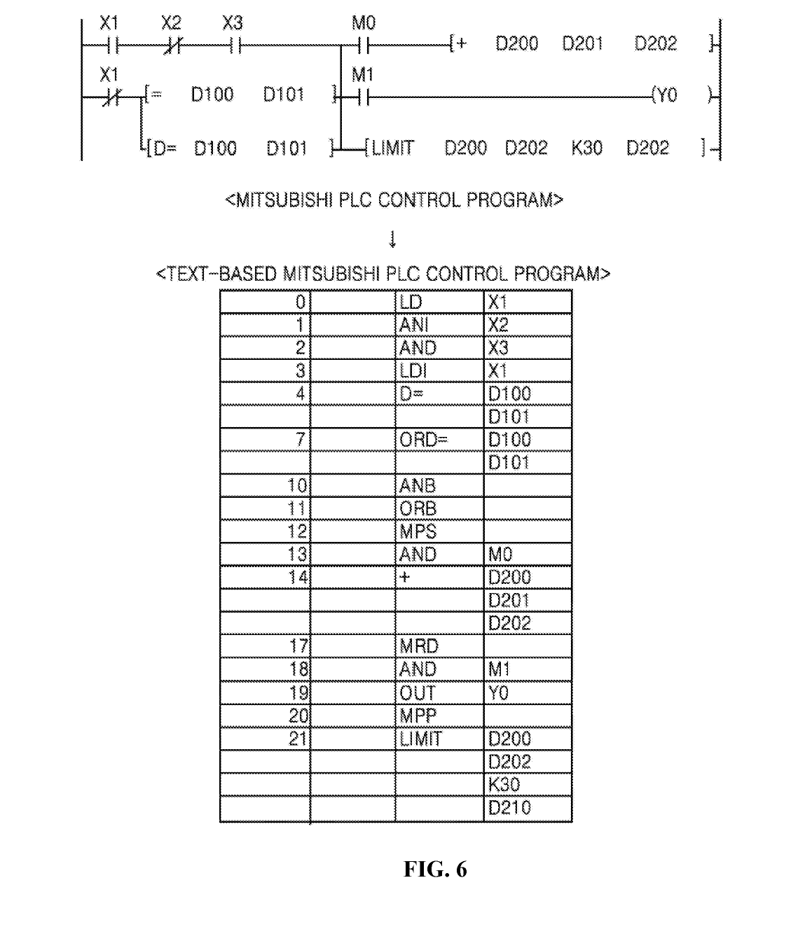

An example of the random text-based PLC control program configured to be convertible into the common type is shown in FIG. 6.

Referring to FIG. 6, a text-based PLC control program of MITSUBISHI with respect to a PLC program of MITSUBISHI having an LD structure is shown.

The text-based PLC control program of MITSUBISHI includes three columns.

Hereinafter, a process of being converted into a common type PLC control program will be described with reference to FIG. 6 for the text-based PLC control program of MITSUBISHI shown therein.

When the random text-based PLC control program requested to be converted into the common type is convertible into the common type PLC control program, the IL object generator 14 generates at least one contact as an IL object which includes a command and a tag according to a logic sequence for each RUNG which forms a control logic of the random text-based PLC control program. That is, throughout the specification, an IL object has the same meaning as that of a contact.

Here, referring to FIG. 6, commands include LD, ANI, AND, LDI, LD=, ORD=, ANB, ORB, MPS, AND, +, MRD, OUT, MPP, LIMIT, and the like, and tags include X1, X2, X3, D100, D101, M0, D200, D201, D202, M1, Y0, K30, D210, and the like. A tag has, for example, a data type “D” and an address “200” like D200 and actually refers to an address value of a memory of PLC hardware.

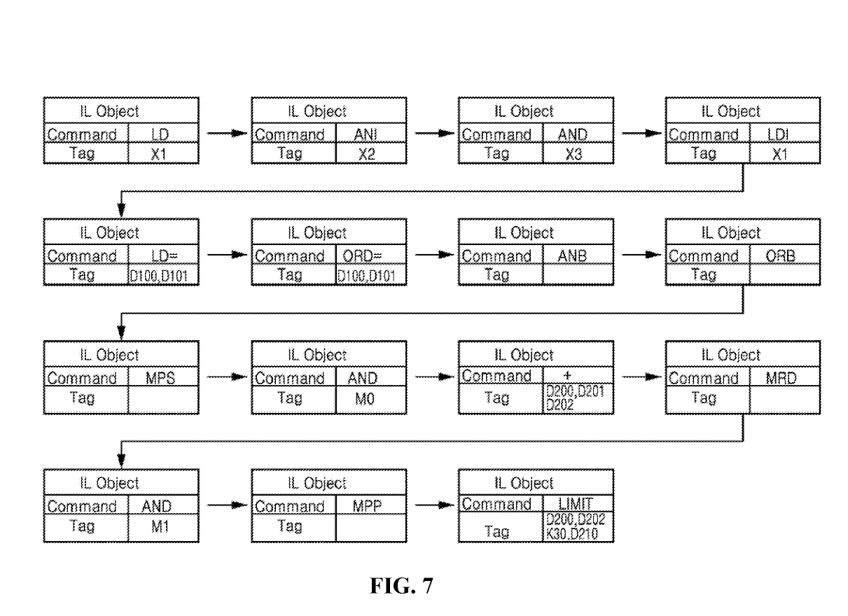

FIG. 7 illustrates IL objects generated according to a result of the operation performed by the IL object generator 14 with respect to the text-based PLC control program of MITSUBISHI shown in FIG. 6.

Referring to FIG. 7, it may be seen that IL objects are arranged according to the control logic sequence of the text-based PLC control program of MITSUBISHI shown in FIG. 6. That is, a sequence of IL objects is the same as the control logic sequence of the text-based PLC control program of MITSUBISHI.

In detail, when IL objects are arranged in an order of commands, “LD”->“ANI”->“AND”->“LDI”->“LD=”->“ORD=”->“ANB”->“ORB”->“MPS”->“AND”->“+”->“MRD”->“AND”->“MPP”->“LIMIT.”

The IL block generator 15 generates one or more IL blocks by blocking one or more IL objects generated by the IL object generator 14 by using a block command.

Here, the block command includes LD, ANB, OR, ORB, MPP, MRD, and MPS.

LD is an abbreviation of load and refers to a contact being loaded on a control logic. Due to LD, blocks of the control logic of the PLC program may be continuously generated.

ANB means an AND block and indicates that two blocks generated ahead an AND command have an AND relationship therebetween.

OR indicates that a symbol in front of an OR command and a symbol of the OR command have an OR relationship therebetween.

ORB means an OR block and indicates that two blocks generated in front of an ORB command have an OR relationship therebetween.

MPS means a multi point start and is disposed at a foremost position in front of a first output contact and contacts having a relationship with the output contact when several output contacts are shown.

MRD means multi read down and is used when three or more output contacts appear.

MPP means a multi point period and is disposed at a foremost position in front of a last output contact and contacts having a relationship with the output contact when several output contacts are shown.

Here, OR, ORB, ANB, MPS, MRD, and MPP among block commands are combination commands used by the combination relationship expresser 17. Among them, the combination commands except an OR command include only commands when being expressed as IL objects and express only a combination relationship between blocks. Accordingly, since they are block combination commands, when the common block converter 16 performs conversion into common blocks, commands of IL objects including corresponding block combination commands are not converted into common commands.

The IL block generator 15 checks whether a block command is included in IL objects while passing the IL objects arranged in a control logic sequence as shown in FIG. 7, and generates new IL blocks when the block command is included. Meanwhile, when the block command is not included, the IL objects are sequentially inserted into previously generated IL blocks before a new block command appears.

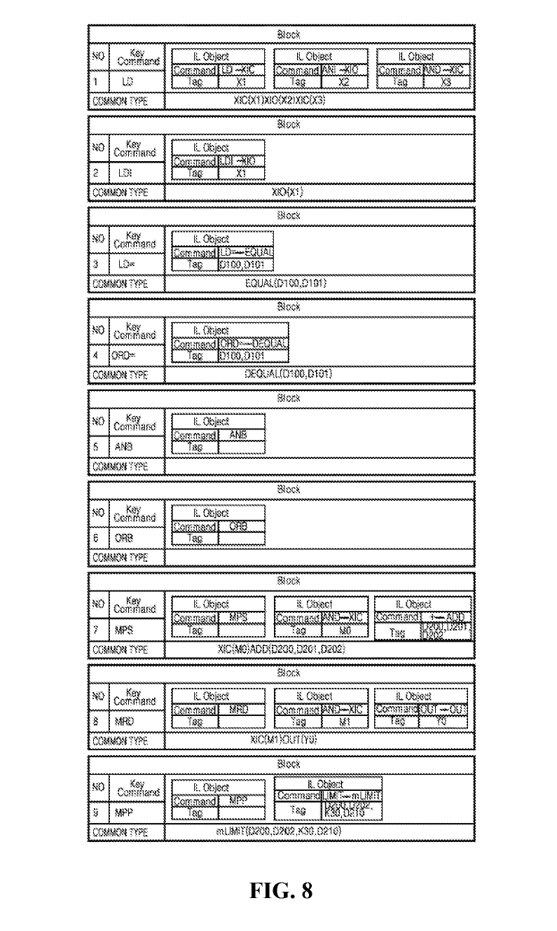

IL blocks generated through the above-described IL block generation process are shown in FIG. 8.

Referring to FIG. 8, the generated IL blocks are totally nine IL blocks.

A first IL block is generated by a block command “LD” and includes three IL objects, that is, an IL object of a command LD, an IL object of a command ANI, and an IL object of a command AND.

Here, LD means load and indicates that a corresponding tag X1 is loaded on a control logic. Actually, when an address X1 of a memory of PLC hardware is turned on, a corresponding contact is turned on.

A second IL block is generated by a block command “LDI” and includes one IL object, that is, an IL object of a command LDI.

Here, LDI means load inverse and indicates that the tag X1 is loaded on the control logic. Since LDI includes a meaning of inverse, a corresponding contact is turned on when the tag X1 is turned off.

A third IL block is generated by a block command “LD=” and includes one IL object, that is, an IL object of a command “LD=.”

Here, “LD=” indicates that a contact having a meaning of “equal” is loaded on the control logic. When values of addresses D100 and D101 included in a contact are same, the corresponding contact is turned on.

A fourth IL block is generated by a block command “ORD” and includes one IL object, that is, an IL object of a command “ORD.”

Here, “ORD=” indicates that the contact having the meaning of “equal” has an OR relationship with a preceding symbol. Since ORD includes “D” after OR, ORD is a command for comparing 32 bits (double words). Accordingly, “ORD=” is a command for comparing a tag D100 with the value of address D100 by using 32 bits.

A fifth IL block is generated by a block command “ANB” and includes one IL object, that is, an IL object of a command “ANB.”

A sixth IL block is generated by a block command “ORB” and includes one IL object, that is, an IL object of a command “ORB.”

A seventh IL block is generated by a block command “MPS” and includes three IL objects, that is, an IL object of a command “MPS,” an IL object of a command “AND”, and an IL object of a command “+.”

Here, the command “+” has a meaning of addition (add) and is a command for adding values of two preceding addresses among values of three addresses included in a contact and storing a value obtained by addition in a last address.

A eighth IL block is generated by a block command “MRD” and includes three IL objects, that is, an IL object of a command “MRD,” an IL object of a command “AND”, and an IL object of a command “OUT.”

A ninth IL block is generated by a block command “MPP” and includes two IL objects, that is, an IL object of a command “MPP” and an IL object of a command “LIMIT.”

The common block converter 16, by using the common command library, generates a common object through converting a command into a common command for each of the one or more IL objects in the one or more IL blocks and converts the one or more IL blocks into one or more common blocks.

The above-described operation of the common block converter 16 will be described with reference to FIG. 8 for IL blocks shown therein.

The common block converter 16, by using the common command library, converts the command in the IL block into the common command and converts the nine IL blocks shown in FIG. 8 into common blocks.

First, with respect to the first IL block, the common block converter 16, by using the common command library, converts the IL object of the command “LD” into a common object of a common command “XIC,” converts the IL object of the command “ANI” into as a common object of a common command “XIO,” converts the IL object of the command “AND” into a common object of a common command “XIC” so as to convert the first IL block into a first common block. Accordingly, a common type of the first common block may be expressed as “XIC(X1)XIO(X2)XIC(X3).”

Here, it is necessary that there are the common command “XIC” with respect to the command “LD,” the common command “XIO” with respect to the command “ANI,” and the common command “XIC” with respect to the command “AND,” which correspond to one another, in the common command library.

With respect to the second IL block, the common block converter 16, by using the common command library, converts the IL object of the command “LDI” into a common object of a common command “XIO” so as to convert the second IL block into a second common block. Accordingly, the common type of the second common block may be expressed as “XIO (X1).”

Here, it is necessary that the common command “XIO” with respect to the command “LDI,” which correspond to each other, are present in the common command library.

With respect to the third IL block, the common block converter 16, by using the common command library, converts the IL object of the command “LD=” into a common object of a common command “EQUAL” so as to convert the third IL block into a third common block. Accordingly, the common type of the third common block may be expressed as “EQUAL (D100 and D101).”

Here, it is necessary that the common command “EQUAL” with respect to the command “LD=”, which correspond to each other, are present in the common command library.

With respect to the fourth IL block, the common block converter 16, by using the common command library, converts the IL object of the command “ORD=” into a common object of a common command “DEQUAL” so as to convert the fourth IL block into a fourth common block. Accordingly, the common type of the fourth common block may be expressed as “DEQUAL (D100 and D101).”

Here, it is necessary that the common command “DEQUAL” with respect to the command “ORD=”, which correspond to each other, are present in the common command library.

Meanwhile, an IL object which includes a combination command may not be converted into a common command with respect to the combination command and may be converted into a common object such that the IL object which includes the combination command may be converted into the common block.

Among block commands, OR, ORB, ANB, MPS, MRD, and MPP are combination commands used by the combination relationship expresser 17. Among them, the combination commands except an OR command include only commands when being expressed as IL objects and express only a combination relationship between blocks. Accordingly, since they are block combination commands, when the common block converter 16 performs conversion into common blocks, commands of IL objects including corresponding block combination commands are not converted into common commands. Accordingly, commands of IL objects which are not converted into common commands are processed as blanks in conversion into common objects and are not expressed.

That is, in an example of FIG. 8, in the case of the IL objects which include block combination commands in the fifth IL block, the sixth IL block, the seventh IL block, the eighth IL block, and the ninth IL block, the commands are not converted into the common commands such that a common type of a common block is not expressed.

With respect to the fifth IL block, the common block converter 16, by using the common command library, does not convert the IL object of the block combination command “ANB” into a common command and converts the fifth IL block into a fifth common block. A common type of the fifth common block is not expressed.

With respect to the sixth IL block, the common block converter 16, by using the common command library, does not convert the IL object of the block combination command “ORB” into a common command and converts the sixth IL block into a sixth common block. A common type of the sixth common block is not expressed.

With respect to the seventh IL block, the common block converter 16, by using common command library, does not convert the IL object of the block combination command “MPS” into a common command, converts the IL object of the command “AND” into the common object of the common command of “XIC,” and converts the IL object of the command “+” into the common object of the common command “ADD” such that the seventh IL block is converted into a seventh common block. Accordingly, a common type of the seventh common block may be expressed as “XIC(M0)ADD(D200,D201,D202).”

Here, it is necessary that the common command “XIC” with respect to the command “AND” and the common command “ADD” with respect to the command “+,” which correspond to one other, are present in the common command library.

With respect to the eighth IL block, the common block converter 16, by using common command library, converts the IL object of the command “MRD” into the common object of the common command of “MRD”, converts the IL object of the command “AND” into the common object of the common command of “XIC,” and converts the IL object of the command “OUT” into the common object of the common command “OUT” such that the eighth IL block is converted into an eighth common block. Accordingly, a common type of the eighth common block may be expressed as “XIC(M1)OUT(Y0).”

Here, it is necessary that the common command “XIC” with respect to the command “AND” and the common command “OUT” with respect to the command “OUT,” which correspond to one other, are present in the common command library.

With respect to the ninth IL block, the common block converter 16, by using the common command library, converts the IL object of the command “MPP” into a common object of the common command “MPP” and converts the IL object of the command “LIMIT” into a common object of the common command “mLIMIT” so as to convert the ninth IL block into a ninth common block. Accordingly, a common type of the ninth common block may be expressed as “mLIMIT(D200,D202,K30,D210).”

Here, it is necessary that the common command “mLIMIT” with respect to the command “LIMIT,” which correspond to each other, are present in the common command library.

When the process of converting the IL blocks into the common blocks is completely finished as described above, a combination relationship among the common blocks is expressed such that the random text-based PLC control program is converted into a common type PLC control program.

Here, the common type PLC control program may be expressed in a common type for at least one RUNG which constitutes a control logic of the text-based PLC control program. The common type RUNG may be started by combining a letter N with a step index of a contact located at a head of a text-based RUNG among contacts in the text-based RUNG.

In the common type RUNG, at least one contact in the text-based RUNG may be expressed as a common object which includes a common command and a tag, and at least one relationship among the common blocks generated by blocking the at least one common object may be expressed as at least one of “[”, “]”, and “,”. Here, symbols “[” and “]” refer to combination points and a symbol “,” refers to a branch point.

Hereinafter, the combination relationship among the common blocks may be expressed by the combination relationship expresser 17 shown in FIG. 2.

The combination relationship expresser 17 expresses the combination relationship between the one or more common blocks as at least one of the symbols “[”, “]”, and “,”.

Here, the combination command may include OR, ORB, ANB, MPP, MPS, and MRD.

An input portion (condition portion) uses the combination commands OR, ANB, and ORB, and an output portion uses the combination commands MPS, MRD, and MPP.

The combination relationship expresser 17 may express the combination relationship among the common blocks expressed in the common type as the symbols “[”, “]”, and “,” by using the combination commands. For this, the combination relationship expresser 17 may express the combination relationship among the common blocks expressed in the common type as at least one of the symbols “[”, “]”, and “,” according to the combination relationship used in the input portion and then may express a relationship among the common blocks expressed in the combination command used in the input portion as at least one of “[”, “]” and “,” according to the combination command used in the output portion.

In the embodiment of the present invention, the combination command used in the input portion is applied to the common blocks expressed in the common type in an order of OR, ANB, and ORB so as to express the combination relationship among the common blocks expressed in the common type as at least one of the symbols “[”, “]”, and “,”. Applying the combination command used in the input portion to the common blocks expressed in the common type in the order of OR, ANB, and ORB is merely an example, and the present invention is not limited thereto.

Also, the combination command used in the output portion is applied to the common blocks expressed by the combination command used in the input portion in an order of MPS->MRD->MPP such that the combination relationship among the common blocks expressed by the common command used in the input portion as at least one of the symbols “[”, “]”, and “,”. Applying the combination command used in the output portion to the common blocks expressed by the combination command used in the input portion in the order of MPS->MRD->MPP is merely an example, and the present disclosure is not limited thereto.

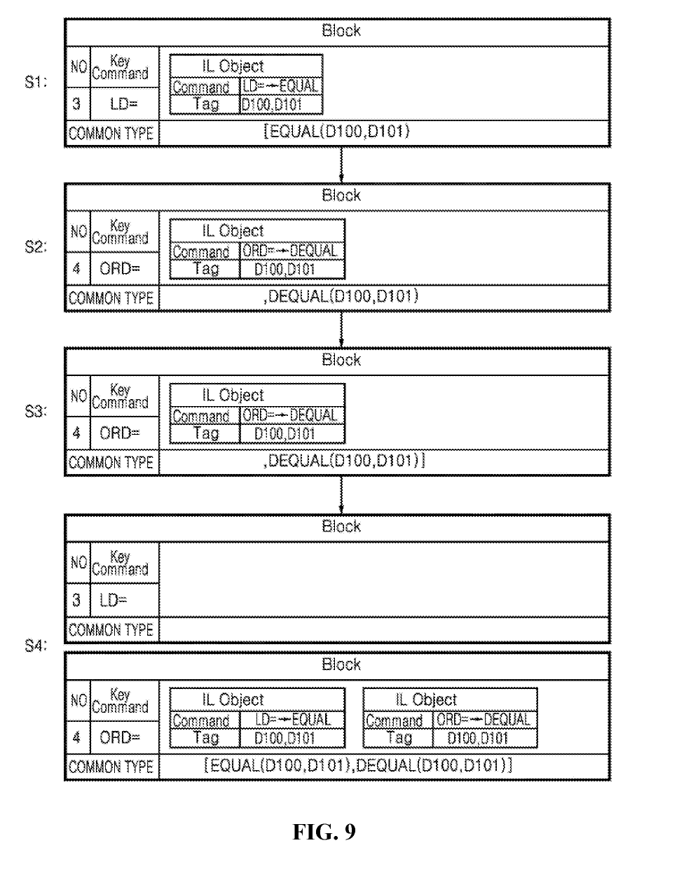

It will be described with reference to FIGS. 9 to 17.

FIG. 9 is a view illustrating the process of expressing the combination relationship among common blocks in the common type by applying the combination command OR to the common blocks shown in FIG. 8.

Referring to FIG. 9, the combination relationship expresser 17 checks whether the common block including the combination command OR is present among the common blocks shown in FIG. 8 and the combination relationship between the two common blocks which are the common blocks including the combination command OR and the common block right ahead by using the symbols “[”, “]”, and “,” when the common block including the combination command OR is present.

In FIG. 9, a combination relationship between the fourth common block including the combination command and the third common block is expressed using the symbols “[”, “]”, and “,”.

It will be described in more detail. First, the symbol “[” is inserted, at a head, into the common type expression of the third common block ahead the fourth common block including the combination command OR (S1).

Then, the symbol “,” is inserted, at a head of, into the common type expression of the fourth common block including the combination command OR (S2).

It is checked whether the fifth common block after the fourth common block including the combination command OR includes the combination command OR. When the fifth common block does not include the combination command OR, the symbol “]” is inserted, at an end, into the common type expression of the fourth common block. When the fifth common block includes the combination command OR, the symbol “,” is inserted, at the end, into the common type expression of the fourth common block (S3).

Then, the common type expression of the third common block is merged with the common type expression of the common block having a later order in the third common block and the fourth common block, that is, the fourth common block (S4).

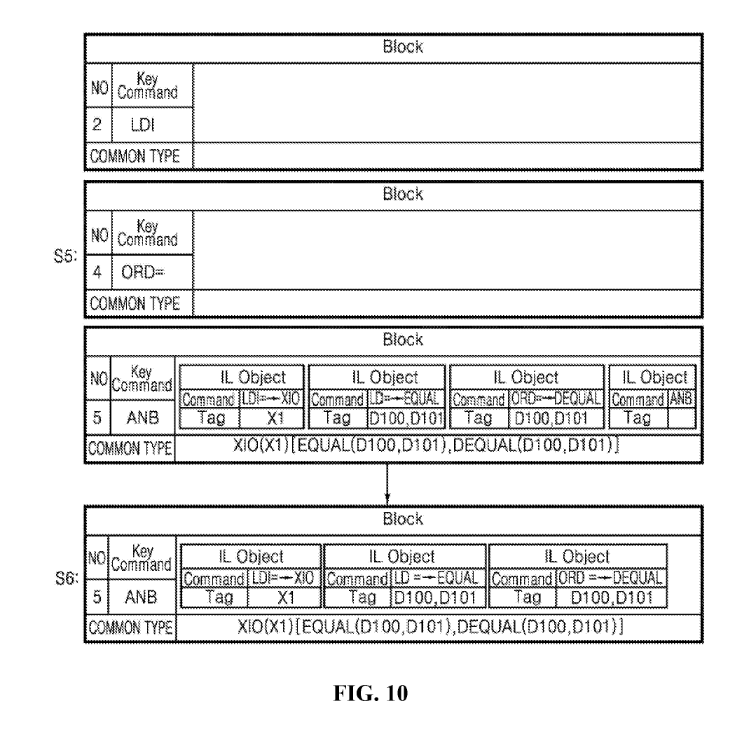

FIG. 10 is a view illustrating the process of expressing the combination relationship among the common blocks in the common type by applying the combination command ANB to the common blocks after applying the combination command OR to the common blocks as shown in FIG. 9.

Referring to FIG. 10, the combination relationship expresser 17 checks whether the common block including the combination command ANB is present in the common blocks after applying the combination command OR to the common blocks in FIG. 9, and when the common block including the combination command ANB is present, the two common blocks ahead the common block including the combination command ANB sequentially merges (S5).

That is, the combination relationship expresser 17 merges the common type expressions of the second common block and the fourth common block ahead the fifth common block including the combination command ANB with the common type expression of the fifth common block.

The merged common type is “XIO(X1)[EQUAL(D100,D101),DEQUAL(D100,D100)].”

Then, the combination relationship expresser 17 deletes the common object including the combination command ANB from the fifth common block with which the second common block and the fourth common block are merged (S6).

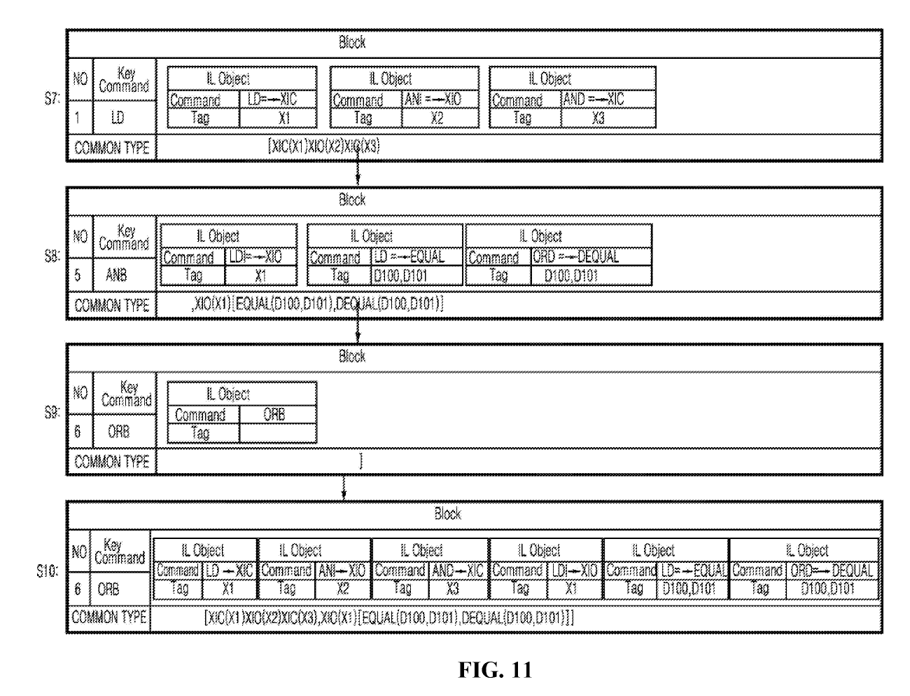

FIG. 11 is a view illustrating a process of expressing the combination relationship among the common blocks by applying the combination command ORB to the common blocks after applying the combination command ANB to the common blocks as shown in FIG. 10.

Referring to FIG. 11, the combination relationship expresser 17 checks whether the common block including the combination command ORB is present in the common blocks after applying the combination command ANB to the common blocks in FIG. 10, and when the common block including the combination command ORB is present, the combination relationship among the common blocks is expressed using the common block including the combination command ORB and two common blocks which are not empty and are ahead the common block including the combination command ORB.

That is, the combination relationship expresser 17 inserts “[” at a head, into the common type expression of the first common block which is a first of the two common blocks which are not empty and are ahead the sixth common block including the combination command ORB (S7).

That is, the combination relationship expresser 17 inserts “,” at a head, into the common type expression of the first common block which is a first of the two common blocks which are not empty and are ahead the sixth common block including the combination command ORB (S8).

The combination relationship expresser 17 checks whether the common block including the combination command OR and the common block including the combination command ORB are present after the sixth common block including the combination command ORB, and only when not present, “]” is inserted into the common type expression of the sixth common block including the combination command ORB currently (S9).

The combination relationship expresser 17 merges the sixth common block, which is latest among the first common block, the fifth common block, and the sixth common block, with the first common block and the fifth common block and deletes the common object including the combination command ORB from the merged sixth common block (S10).

The common type merged as described above is “[XIC(X1)XIO(X2)XIC(X3),XIO(X1)[EQUAL(D100,D101),DEQUAL(D100,D100)]].”

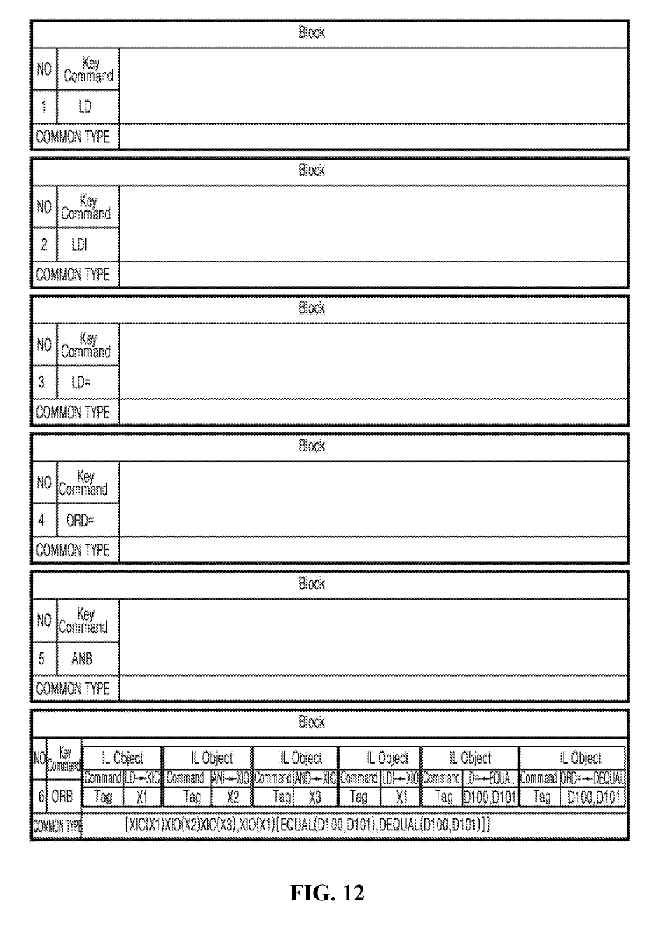

FIG. 12 is a view illustrating shapes of the common blocks obtained by applying OR, ANB, and ORB to the common blocks shown in FIG. 8.

Referring to FIG. 12, it may be seen that the first to fifth common blocks are merged with the sixth common block by sequentially applying the combination commands OR, ANB, and ORB used in the input portion to the common blocks shown in FIG. 8.

It may be seen that the common type which expresses the combination relationship among the first to six common blocks is “[XIC(X1)XIO(X2)XIC(X3),XIO(X1)[EQUAL(D100,D101),DEQUAL(D100,D100)]].”

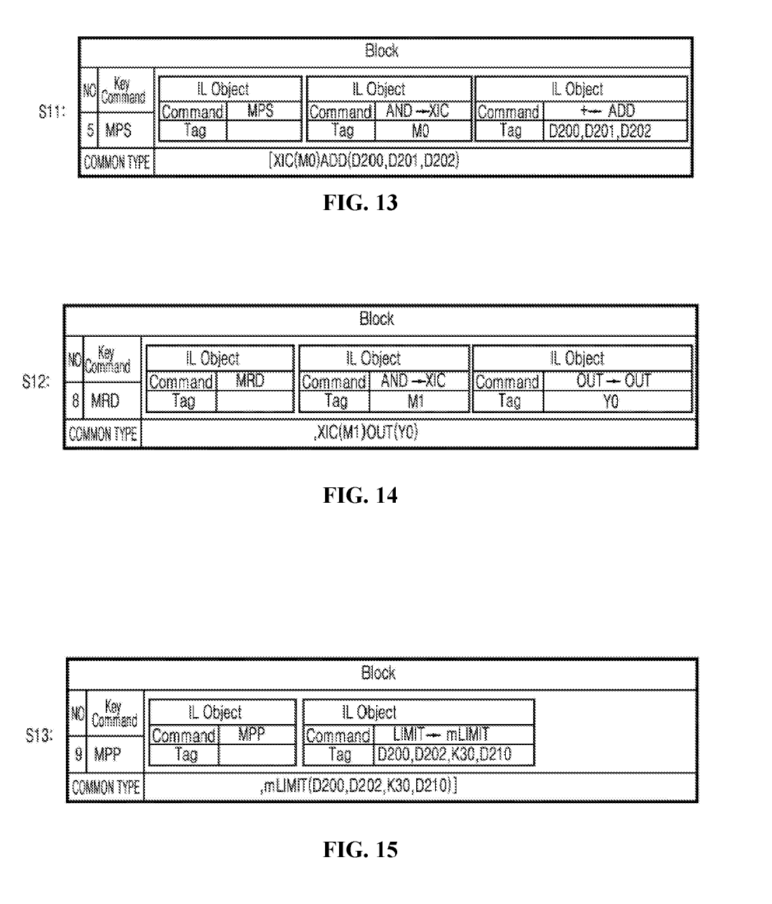

FIG. 13 is a view illustrating a result of applying the combination command MPS used by the output portion to the common blocks shown in FIG. 12.

Referring to FIG. 13, the combination relationship expresser 17 checks whether the common block including the combination command MPS used by the output portion is present in the common blocks shown in FIG. 12, and when the common block including the combination command MPS is present, the combination relationship expresser 17 inserts “[” at a head, into the common type expression of the corresponding common block (S11).

That is, the combination relationship expresser 17 inserts “[” at a head of the common type expression of the seventh common block including the combination command MPS.

Accordingly, the common type of the seventh common block becomes “XIC(M0)ADD(D200,D201,D202).”

FIG. 14 is a view illustrating a result of applying the combination command MRD used by the output portion to the common blocks shown in FIG. 12.

Referring to FIG. 14, the combination relationship expresser 17 checks whether the common block including the combination command MRD used by the output portion is present in the common blocks shown in FIG. 12, and when the common block including the combination command MRD is present, the combination relationship expresser 17 inserts “,”, at a head, into the common type expression of the corresponding common block (S12).

That is, the combination relationship expresser 17 inserts “,”, at a head of the common type expression of the eighth common block including the combination command MRD.

Accordingly, the common type of the eighth common block becomes “,XIC(M1)OUT(Y0).”

FIG. 15 is a view illustrating a result of applying the combination command MPP used by the output portion to the common blocks shown in FIG. 12.

Referring to FIG. 15, the combination relationship expresser 17 checks whether the common block including the combination command MPP used by the output portion is present in the common blocks shown in FIG. 12, and when the common block including the combination command MPP is present, the combination relationship expresser 17 inserts “,”, at a head, into the common type expression of the corresponding common block and inserts “]” at an end, into the common type expression of the corresponding common block (S13).

That is, the combination relationship expresser 17 inserts “,” at a head, and “]” at an end, into the common type expression of the ninth common block including the combination command MPPfmf.

Accordingly, the common type of the ninth common block is “,mLIMIT(D200,D202,K30,D210)].”

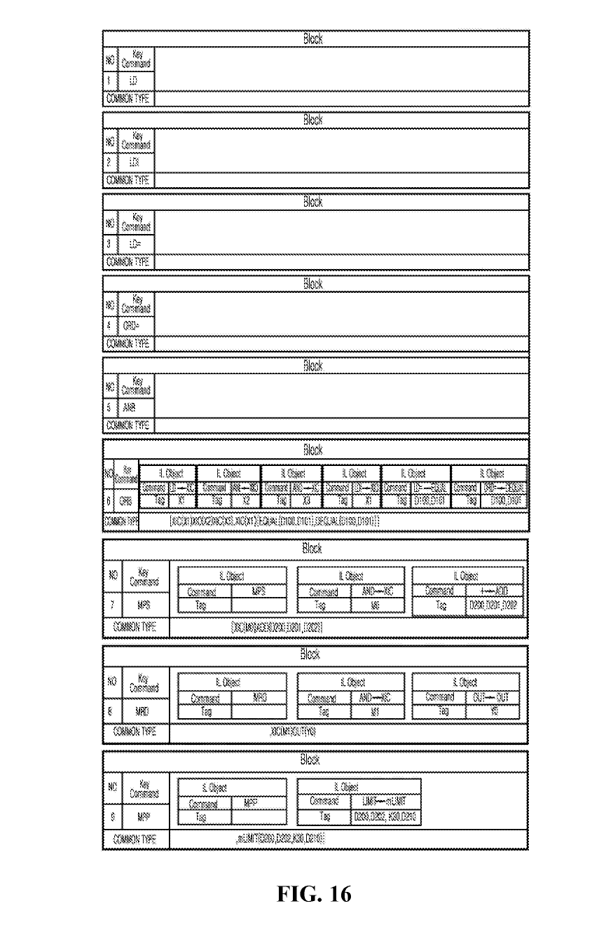

FIG. 16 is a view illustrating shapes of the common blocks obtained by applying MPS, MRD, and MPP to the common blocks shown in FIG. 12.

Referring to FIG. 16, it may be seen that the symbols for indicating combination relationships are inserted into the common type expression of the seventh common block to the ninth common block corresponding to the output portion by applying the combination commands MPS, MRD, and MPP used by the output portion to the common blocks shown in FIG. 12.

It may be seen that the common type of the seventh common block is “[XIC(M0)ADD(D200,D201,D202),” the common type of the eighth common block is “,XIC(M1)OUT(Y0),” and the common type of the ninth common block is “,mLIMIT(D200,D202,K30,D210)].”

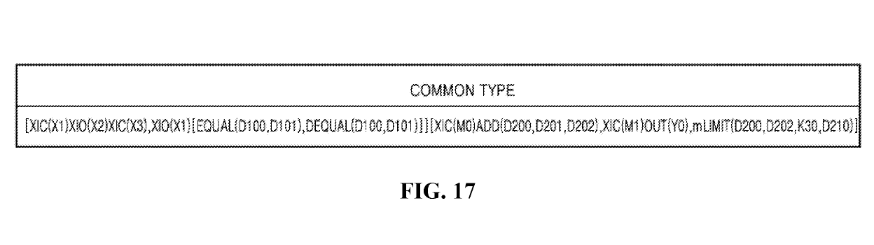

A result of merging the common blocks obtained by applying the combination command used by the input portion and the combination command used by the output portion to the common blocks shown in FIG. 8 is shown in FIG. 17.

Referring to FIG. 17, it may be seen that result of merging the common blocks obtained by applying the combination command used by the input portion and the combination command used by the output portion to the common blocks shown in FIG. 8 is “[XIC(X1)XIO(X2)XIC(X3),XIO(X1)[EQUAL(D100,D101),DEQUAL(D100,D100)]] [XIC(M0) ADD(D200,D201,D202),XIC(M1)OUT(Y0),mLIMIT(D200,D202,K30,D210)]”

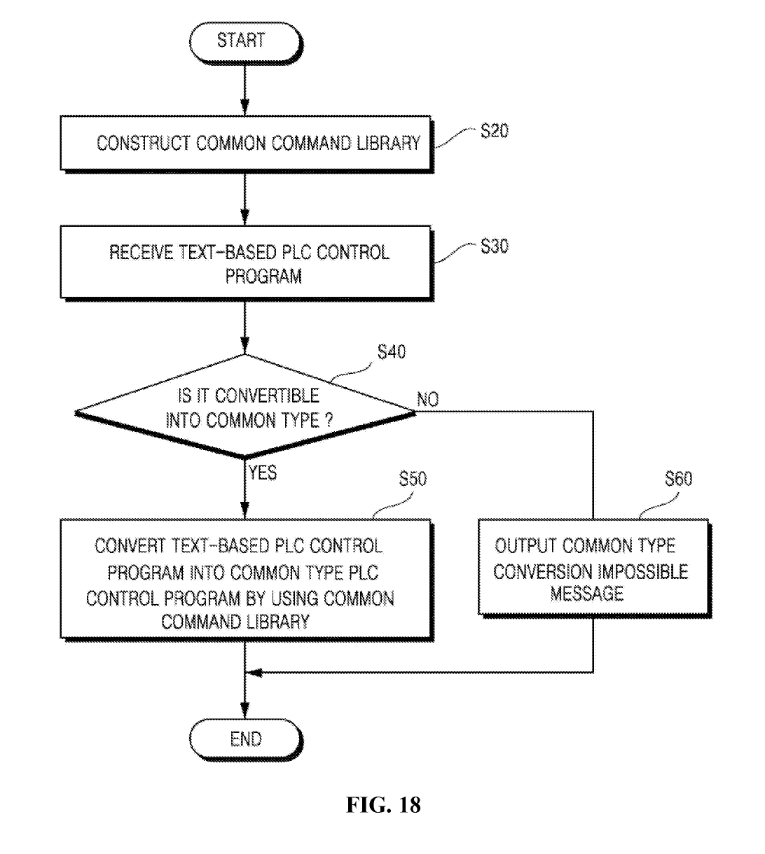

FIG. 18 is a flowchart illustrating a common type conversion method for a PLC control program according to one embodiment of the present invention.

The common type conversion method for a PLC control program according to one embodiment of the present invention may be performed by the common type conversion device 10 shown in FIG. 1 but is not limited thereto.

Referring to FIG. 18, the construction portion 11 of the common type conversion device 10 generates a common command with respect to commands used in text-based PLC control programs having different formats by using a common command generation algorithm so as to construct a common command library (S20).

The common type conversion portion 13 of the common type conversion device 10, according to a request for converting a random text-based PLC control program into a common type (S30), checks whether the random text-based PLC control program is convertible into a common type PLC control program by using a filename extension and a data structure of the random text-based PLC control program (S40).

When the random text-based PLC control program is convertible into the common type PLC control program as a result of checking, the common type conversion portion 13 converts the random text-based PLC control program into the common type PLC control program by using the common command library (S50).

Meanwhile, when the random text-based PLC control program is inconvertible into the common type PLC control program, the common type conversion portion 13 generates and transmits a common type conversion impossible message to a common type conversion requestor (a terminal of a requestor) (S60).

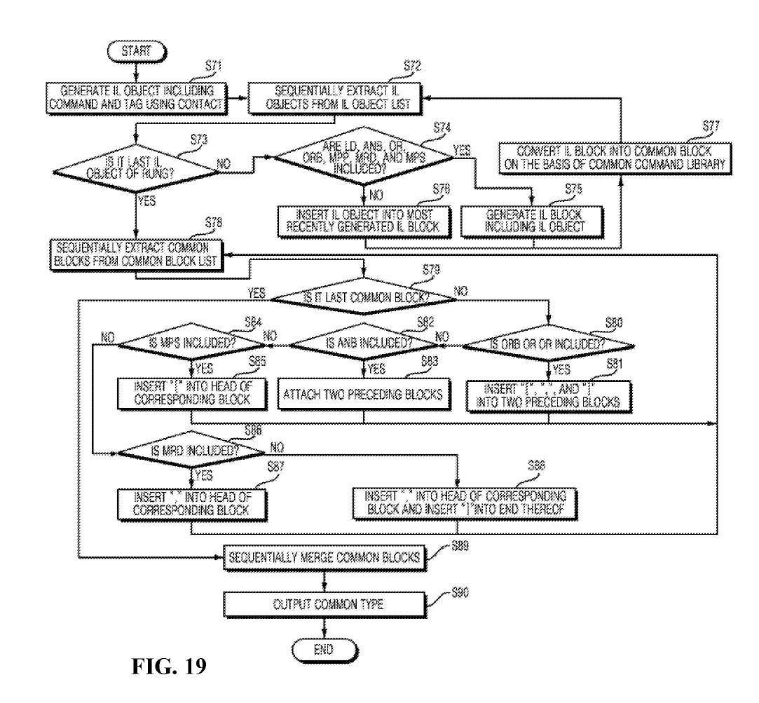

A method of common type conversion with respect to a random text-based PLC control program performed by the common type conversion portion 13 shown in FIG. 19 may be performed by the IL object generator 14, the IL block generator 15, the common block converter 16, and the combination relationship expresser 17, which are included in the common type conversion portion 13 as shown in FIG. 13.

Referring to FIG. 19, when the random text-based PLC control program requested to be converted into the common type is convertible into the common type PLC control program, the IL object generator 14 generates an IL object which includes a command and a tag by using at least one contact according to a logic sequence for each RUNG which forms a control logic of the random text-based PLC control program (S71).

The IL block generator 15 generates at least one IL block by blocking one or more IL objects by using a block command. It may correspond to operations S72 to S76 in FIG. 19.

That is, the IL block generator 15 sequentially extracts IL objects from an IL object list (S72) until a last IL object of RUNG is extracted (S73). The IL block generator 15 checks whether commands “LD, AND, OR, ORB, MPP, MRD, and MPS” are included in the IL objects (S74). When they are included therein, the IL block generator 15 generates new IL blocks (S75). When they are not included therein, an IL object is inserted into a most-recently generated IL block (S76). The operations S72 to S76 are repeatedly performed.

The common block converter 16, by using a common command library, generates a common object through converting a command into a common command for each of the one or more IL objects in the one or more IL blocks and converts the one or more IL blocks into one or more common blocks (S77).

The combination relationship expresser 17 expresses a combination relationship between the one or more common blocks as at least one of the symbols “[”, “]”, and “,”. It will be performed through operations S78 to S90 in FIG. 19.

That is, the combination relationship expresser 17 sequentially extracts the common blocks shown in FIG. 8 (S78) and checks whether the extracted common block is a last common block (S79).

When the extracted common block is not the last common block, the combination relationship expresser 17 checks whether a combination command ORB or OR is included in the extracted common block (S80). When it is included therein, “[”, “,”, and “]” are inserted into two preceding common blocks (S81).

When the combination command ORB or OR is not included in the extracted common block, the combination relationship expresser 17 checks whether a combination command ANB is included in the extracted common block (S82). When it is included therein, two preceding common blocks of the extracted common block are attached (S83).

When the combination command ANB is not included in the extracted common block, the combination relationship expresser 17 checks whether a combination command MPS is included in the extracted common block (S84). When it is included therein, “[” is inserted into a head of the corresponding common block (S85).

When the combination command MPS is not included in the extracted common block, the combination relationship expresser 17 checks whether a combination command MRD is included in the extracted common block (S86). When it is included therein, “,” is inserted into a head of the corresponding common block (S87).

When the combination command MRD is not included in the extracted common block, the combination relationship expresser 17 determines that the combination command MPP is included in the extracted common block, and the combination relationship expresser 17 inserts “,” into a head of the corresponding common block and inserts “]” into an end thereof (S88).

Meanwhile, when it is determined that the extracted common block is the last common block in the operation S79, the combination relationship expresser 17 sequentially merges common blocks with a combination relationship expressed in a common type (S89) and outputs a common type in which a combination relationship among the merged common blocks is expressed (S90).

Although the exemplary embodiments of the present invention have been described above, one of ordinary skill in the art can understand that a variety of modifications may be made without departing from the essential features of the present invention. Therefore, the disclosed embodiments should be considered in a descriptive aspect not in a limitative aspect. Accordingly, the scope of the present invention is not limited to the above-described embodiments and should be understood as including a variety of embodiments within the range of the content stated in the claims and equivalents thereof.

### INDUSTRIAL APPLICABILITY

The present invention may be utilized in the field of developing a programmable logic controller (PLC) control program.

What is claimed is:

1. A common type conversion device for a programmable logic controller (PLC) control program, comprising:
a common command library construction portion which generates a common command with respect to commands used in text-based PLC control programs having different formats by using a common command generation algorithm so as to construct a common command library; and
a common type conversion portion, when a random text-based PLC control program requested to be a common type is convertible into a common type PLC control program, converting the random text-based PLC control program into the common type PLC control program by using the common command library.

2. The common type conversion device of claim 1, wherein the common command generation algorithm comprises:
a first operation of classifying the commands used in text-based PLC control programs having different formats into same expression command groups having the same meaning in expression;
a second operation of checking whether commands included in one of the same expression command groups have the same function; and
a third operation of generating, when the commands included in the same expression command group have the same function, a word in dictionary, which equally expresses the commands included in the same expression command group, as a common command with respect to the commands having the same function, generating, when all the commands included in the same expression command group do not have the same function, a word in dictionary, which expresses all the commands which are included in the same expression command group but do not have the same function, as a common command with respect to the commands which do not have the same function, and inserting a title of a manufacturer of a PLC controlled by a PLC control program in which the commands which do not have the same function are used, into the common command with respect to the commands which do not have the same function.

3. The common type conversion device of claim 2, wherein the third operation comprises inserting, when the common command with respect to the commands having the same function is generated, a parameter modifier included in the commands having the same function into the common command with respect to the commands having the same function.

4. The common type conversion device of claim 2, wherein the third operation comprises inserting, when the common command with respect to the commands having the same function is generated, an operation modifier included in the commands having the same function into the common command with respect to the commands having the same function.

5. The common type conversion device of claim 2, wherein the third operation comprises inserting, when the common command with respect to the commands which do not have the same function is generated, a parameter modifier included in the commands which do not have the same function into the common command with respect to the commands which do not have the same function.

6. The common type conversion device of claim 2, wherein the third operation comprises inserting, when the common command with respect to the commands which do not have the same function is generated, an operation modifier included in the commands which do not have the same function into the common command with respect to the commands which do not have the same function.

7. The common type conversion device of claim 1, wherein the common type PLC control program is expressed in a common type for at least one RUNG which forms a control logic of the text-based PLC control program,
wherein a common type RUNG is started by combining a letter “N” with a step index of a contact located at a foremost position of a text-based RUNG among inner contacts of the text-based RUNG, and
wherein in the common type RUNG, at least one contact in the text-based RUNG is expressed as a common object which includes a common command and a tag, and a combination relationship among one or more common blocks generated by blocking one or more common objects is expressed as at lest one of symbols “[”, “]”, and “,”.

8. The common type conversion device of claim 7, wherein the common type conversion portion comprises:
an instruction list (IL) object generator configured to generate, when a random text-based PLC control program requested to be a common type is convertible into a common type PLC control program, at least one contact as an IL object which includes a command and a tag according to a logic sequence for each RUNG which constitutes a control logic of the random text-based PLC control program;
an IL block generator configured to generate one or more IL blocks by blocking one or more IL objects by using a block command;
a common block converter configured to convert the one or more IL blocks into one or more common blocks by generating a common object through conversion of a command for each of the one or more IL objects in the one or more IL blocks into a common command by using the common command library; and
a combination relationship expresser configured to express a combination relationship among the one or more common blocks as at least one of the symbols “[”, “]”, and “,” by using a combination command.

9. A common type conversion method for a PLC control program, comprising:
constructing a common command library by generating a common command with respect to commands used in text-based PLC control programs having different formats by using a common command generation algorithm;
checking, according to a request for converting a random text-based PLC control program into a common type, whether the random text-based PLC control program is convertible into the common type PLC control program by using a filename extension and a data structure of the random text-based PLC control program; and
converting, when the random text-based PLC control program is convertible into the common type PLC control program, the random text-based PLC control program into the common type PLC control program by using the common command library.

10. The common type conversion method of claim 9, wherein the common command generation algorithm comprises:
a first operation of classifying the commands used in text-based PLC control programs having different formats into same expression command groups having the same meaning in expression;
a second operation of checking whether commands included in one of the same expression command groups have the same function; and
a third operation of generating, when the commands included in the same expression command group have the same function, a word in dictionary, which equally expresses the commands included in the same expression command group, as a common command with respect to the commands having the same function, generating, when all the commands included in the same expression command group do not have the same function, a word in dictionary, which expresses all the commands which are included in the same expression command group but do not have the same function, as a common command with respect to the commands which do not have the same function, and inserting a title of a manufacturer of a PLC controlled by a PLC control program in which the commands which do not have the same function are used, into the common command with respect to the commands which do not have the same function.

11. The common type conversion method of claim 10, wherein the third operation comprises inserting, when the common command with respect to the commands having the same function is generated, a parameter modifier included in the commands having the same function into the common command with respect to the commands having the same function.

12. The common type conversion method of claim 10, wherein the third operation comprises inserting, when the common command with respect to the commands having the same function is generated, an operation modifier included in the commands having the same function into the common command with respect to the commands having the same function.

13. The common type conversion method of claim 10, wherein the third operation comprises inserting, when the common command with respect to the commands which do not have the same function is generated, a parameter modifier included in the commands which do not have the same function into the common command with respect to the commands which do not have the same function.

14. The common type conversion method of claim 10, wherein the third operation comprises inserting, when the common command with respect to the commands which do not have the same function is generated, an operation modifier included in the commands which do not have the same function into the common command with respect to the commands which do not have the same function.

15. The common type conversion method of claim 9, wherein the common type PLC control program is expressed in a common type for at least one RUNG which forms a control logic of the text-based PLC control program,
wherein a common type RUNG is started by combining a letter “N” with a step index of a contact located at a foremost position of a text-based RUNG among inner contacts of the text-based RUNG, and
wherein in the common type RUNG, at least one contact in the text-based RUNG is expressed as a common object which includes a common command and a tag, and a combination relationship among one or more common blocks generated by blocking one or more common objects is expressed as at lest one of symbols “[”, “]” , and “,”.

16. The common type conversion method of claim 15, wherein the converting of the random text-based PLC control program into the common type PLC control program comprises:
generating, when a random text-based PLC control program requested to be a common type is convertible into a common type PLC control program, at least one contact as an IL object which includes a command and a tag according to a logic sequence for each RUNG which constitutes a control logic of the random text-based PLC control program;
generating one or more IL blocks by blocking one or more IL objects by using a block command;
converting the one or more IL blocks into one or more common blocks by generating a common object through conversion of a command for each of the one or more IL objects in the one or more IL blocks into a common command by using the common command library; and
expressing a combination relationship among the one or more common blocks as at least one of the symbols “[”, “]”, and “,” by using a combination command.
